(19) United States
(12) Patent Application Publication
(10) Pub. No.: US 2002/0110367 A1
(43) Pub. Date: Aug. 15, 2002

(54) Recording device with a still picture record mode

(75) Inventor: Franz Schuegerl, Vienna (AT)

Correspondence Address: U.S. Philips Corporation, 580 White Plains Road, Tarrytown, NY, 10591, US

(73) Assignee: KONINKLIJKE PHILIPS ELECTRONICS N.V.

(21) Appl. No.: 10/066,987

(22) Filed: Feb. 4, 2002

(30) Foreign Application Priority Data
Feb. 13, 2001 (EP) 01890038.1

(51) Int. Cl. H04N 5/92; H04N 5/76

(52) U.S. Cl. 386/96; 386/98

(57) ABSTRACT

In a recording device (1), a frame recording mode can be activated, in which the overall audio information of a television broadcast and selected frames of the television broadcast are recorded on a record carrier (11). A reproducing device (1) is adapted in a frame reproducing mode for reproducing the overall audio information and the selected frames of the recorded television broadcast. Consequently, a user can record, for example, the complete music of a concert and additionally record characteristic frames of the concert on a record carrier (11) and reproduce them at a later stage. This requires a very small memory location on the record carrier (11) for recording the concert.

The invention relates to a recording device for recording audio data and associated video data of a television broadcast in a frame recording mode, requiring a very small memory location on the record carrier.

The invention also relates to a reproducing device for reproducing audio data and video data recorded in the special recording mode by means of a recording device as described in the opening paragraph.

The invention further relates to a method of recording audio data and associated video data of a television broadcast, requiring a very small memory location on the record carrier.

The document U.S. Pat. No. 5,883,672 discloses a video encoder for encoding picture information of a television broadcast and for supplying corresponding video data. The video data supplied by the known video encoder comprise the picture information in intraframe-encoded I frames and in intraframe-encoded B frames and P frames. An I frame as well as B frames and P frames are combined in a Group of Pictures.

Each I frame comprises information on a frame with which this frame can be decoded by a corresponding video decoder, independently of the information in the neighboring B frames and P frames of the Group of Pictures. P frames can be computed by taking so-called motion vectors from the previous I frame into account and B frames are determined by interpolation of the P frames neighboring the B frame.

The video data supplied by the known video encoder comprise complete picture information of the television broadcast and can be recorded on a record carrier jointly with audio data comprising audio information of the television broadcast by a recording device such as, for example, a hard disk recorder or a DVD recorder. Since the picture information is compressed by the video encoder, the required memory location of the record carrier for recording the television broadcast is comparatively small.

In recording the television broadcasts determined by the picture information encoded by the known video encoder on the record carrier, it has, however, proved that it would be desirable to use an essentially smaller required memory location on the record carrier so as to allow a substantially longer recording period on the same record carrier.

It is an object of the invention to provide a recording device of the type described in the opening paragraph and a recording method as described in the third paragraph, in which a substantially longer recording period on the same record carrier is possible without losing essential information contents of the television broadcast to be recorded. It is a further object of the invention to provide a reproducing device as described in the second paragraph, with which the audio data and video data recorded by the recording device can be reproduced.

The invention is based on the recognition that the picture information of many television broadcasts such as, for example, news reports, documentary films or concerts comprise quite a lot of redundant picture information. When a news broadcast lasts, for example, ten minutes, there are usually eight minutes in which the news reader reads the text and short reports are shown during the remaining two minutes.

To solve the above-mentioned object, such a recording device according to the invention has characteristic features by which the recording device can be characterized in the following way.

A recording device for recording audio data and selected associated video data of a television broadcast in a frame recording mode, the device comprising

receiving means for receiving audio data and associated video data, in which the received video data comprise, inter alia, intraframe-encoded information of frames of the television broadcast and time-stamp information, which time-stamp information characterizes the instants of occurrence of the frames in the television broadcast, and

selection means for selecting the video data comprising the frame information and associated time-stamp information from the received video data, and

selection means for selecting at least one and maximally N of the frames selected during a partial broadcast period, which partial broadcast period corresponds to a part of the overall broadcast period of the television broadcast, and

recording means for recording the overall received audio data and the selected video data comprising the information of the selected frames and associated time-stamp information on a record carrier.

To solve the above-mentioned object, such a recording method has characteristic features according to the invention, so that the recording method can be characterized in the following way.

A method of recording audio data and selected associated video data of a television broadcast in a frame recording mode, the method comprising the steps of

receiving audio data and associated video data, wherein the received video data comprise, inter alia, intraframe-encoded information of frames of the television broadcast and time-stamp information, which time-stamp information characterizes the instants of occurrence of the frames in the television broadcast,

selecting the video data comprising the frame information and associated time-stamp information from the received video data,

selecting at least one and maximally N of the frames selected during a partial broadcast period, which partial broadcast period corresponds to a part of the overall broadcast period of the television broadcast,

recording the overall received audio data and the selected video data comprising the frame information of the selected frames and associated time-stamp information on a record carrier.

This provides the advantage that the user of the recording device can select the frame recording mode for recording given television broadcasts, in which, however, of the overall audio information of the television broadcast, only essential frames (maximally N per partial broadcast period) of the picture information of the television broadcast are recorded on the record carrier. In this frame recording mode, however, only a given number of frames (for example, overall recording of the orchestra; close-up of the conductor, . . .) of a five-hour concert is recorded so that the memory location required for recording the concert on the record carrier is only very small.

In accordance with the measures defined in claim 2 and claim 10, the advantage is obtained that at least one frame is recorded for each scene of the television broadcast recorded in the frame recording mode.

In accordance with the measures as defined in claim 3 and claim 11, the advantage is obtained that, when a frame of the television broadcast to be recorded strongly deviates from the last recorded frame, this frame is also recorded. It is thereby ensured that no essential picture information of the television broadcast is lost.

In accordance with the measures as defined in claim 4, the advantage is obtained that a frame can already be reproduced from the start of reproducing the picture in the case of a later reproduction of the recorded audio data and video data.

In accordance with the measures as defined in claim 5, minimally one and maximally five frames of one minute of broadcasting time of the television broadcast are recorded, which, in practice, has proved to be advantageous for limiting the required memory location.

To solve the above-mentioned object, such a reproducing device according to the invention has characteristic features so that the reproducing device can be characterized in the following way.

A reproducing device for reproducing audio data and video data in a frame recording mode, recorded on a record carrier by means of a recording device as defined in claim 1 in a frame recording mode of the recording device, the device comprising

reproducing means for reproducing the audio data and video data recorded on the record carrier, wherein the reproduced video data are formed by intraframe-encoded information of frames of a television broadcast and by time-stamp information, which time-stamp information characterizes the instant of occurrence of the frames in the television broadcast, and

supply means for continuously supplying the reproduced audio data and for time-limited supplying the reproduced information of a frame during a frame reproducing period, in which the start of the frame reproducing period is characterized by the time-stamp information assigned to the reproduced frame, and in which the end of the frame reproducing period is characterized by the time-stamp information assigned to the frame to be subsequently reproduced.

This provides the advantage that the reproducing device continuously reproduces the audio information recorded by the recording device in the frame recording mode, so that the user can listen to, for example, the music of the complete concert or the news text of the complete news broadcast. Fitting with the reproduction of the audio information, the recorded frames are reproduced until the next frame has occurred in the television broadcast.

These and other aspects of the invention are apparent from and will be elucidated with reference to the embodiments described hereinafter.

In the drawings:

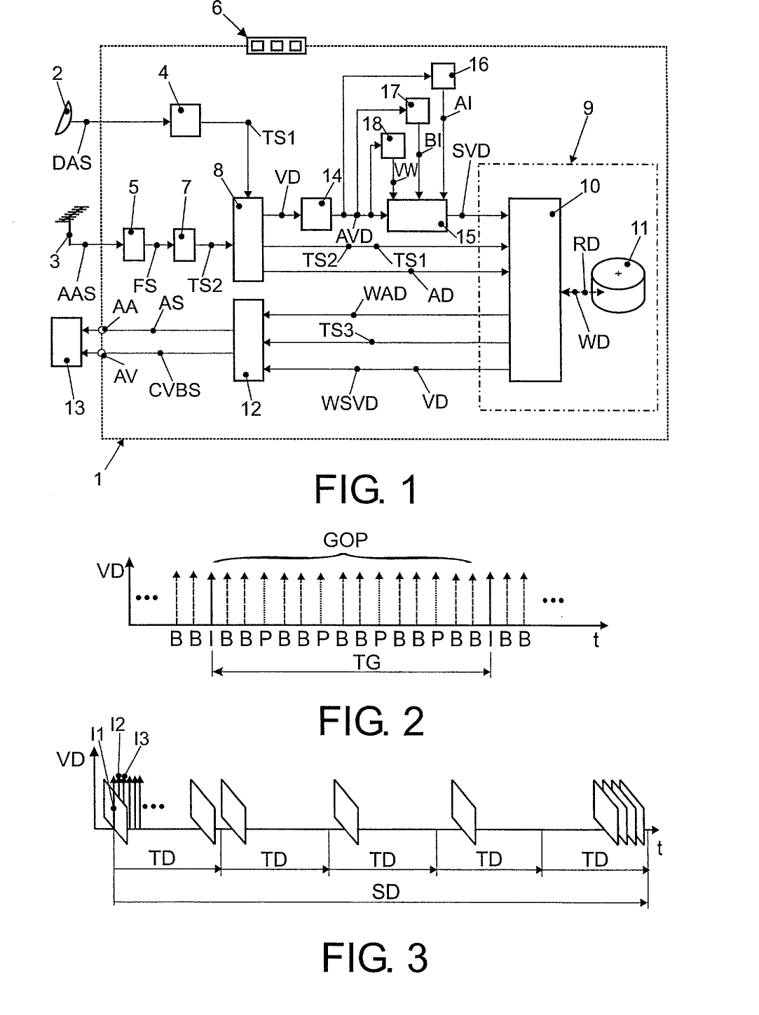

FIG. 1 shows a hard disk recorder in the form of a block diagram in which a frame recording mode and a frame reproducing mode can be activated.

FIG. 2 shows symbolically a Group of Pictures of video data which can be received by the hard disk recorder.

FIG. 3 shows frames (I frames) selected by selection means of the hard disk recorder and selected frames selected by selection means of the hard disk recorder and recorded by the hard disk recorder.

FIG. 1 shows a hard disk recorder which constitutes a recording device for recording audio data AD and selected associated video data SVD of a television broadcast in a frame recording mode. The hard disk recorder 1 further constitutes a reproducing device for reproducing the audio data AD recorded in the frame recording mode and selected associated video data SVD reproduced in a frame reproducing mode.

A satellite antenna 2 for receiving a digital antenna signal DAS is connected to the hard disk recorder 1. A DVB signal (Digital Video Broadcast signal) can be received in the digital antenna signal DAS, which signal may comprise a plurality of MPEG-2 transport streams TS or MPEG-2 program streams which are fixed in the MPEG-2 standard (ISO/IEC 13818). Each of these MPEG-2 transport streams TS comprises data packets in which audio information, video information, time-stamp information and possibly additional information of television broadcasts by a television broadcast station are transported.

The data packets of such an MPEG-2 transport stream TS comprising the video information comprise video data VD whose structure is symbolically shown in FIG. 2. The video data VD comprise I-frames I, B-frames B and P-frames P, in which a so-called Group of Pictures GOP comprises one I-frame I, ten B-frames B and four P-frames P in the sequence shown in FIG. 2.

The I-frames I are encoded in accordance with an intraframe encoding method which ensures that each I-frame I comprises all picture information and all frame information of a reproducible frame. The P-frames P and the B-frames B are encoded in accordance with an interframe encoding method. In this method, P-frames P are computed by taking into account so-called motion vectors from the previous I-frame I. B-frames B are determined by interpolation with the P-frames P neighboring each B-frame B. Time-stamp information is assigned to at least each of these I-frames I, which information characterizes the instant of occurrence of the assigned I-frame during the broadcast period SD of the television broadcast transmitted in the MPEG-2 transport stream TS.

The Group of Pictures GOP comprises video information of the transmitted television broadcast which are sufficient for reproducing the picture contents of the television broadcast for a group broadcast period TG of, for example, half a second. A television broadcast with an overall broadcast period SD of, for example, one hour, thus comprises a number of SD divided by TG (3,600 seconds/0.5 seconds), i.e. a number of 7,200 Group of Pictures GOP and an equally large number of I-frames I.

A terrestrial antenna 3 for receiving an analog antenna signal AAS is also connected to the hard disk recorder 1. In the analog antenna signal AAS, television signals FS from a plurality of television broadcast stations can be transmitted. Each of these television signals FS comprises audio information, video information and possibly additional information of the television broadcasts of each television broadcast station.

The hard disk recorder 1 comprises a digital tuner 4, an analog tuner 5 and a keyboard 6. The digital antenna signal DAS from the satellite antenna 2 can be supplied to the digital tuner 4 and the analog antenna signal AAS from the terrestrial antenna 3 can be supplied to the analog tuner 5. By activating one of the keys of the keyboard 6, a user of the hard disk recorder 1 can select a television broadcast station which can be received by the digital tuner 4 or by the analog tuner 5. In a manner not further shown in FIG. 1, corresponding control information can be supplied by the keyboard 6 to the digital tuner 4 or the analog tuner 5. A first MPEG-2 transport stream TS1 of the television broadcast station selected by the user can thus be supplied by the digital tuner 4 and the television signal FS of the television broadcast station selected by the user can be supplied by the analog tuner 5.

The hard disk recorder 1 further comprises an MPEG encoder 7 to which the television signal FS which can be supplied by the analog tuner 5 can be applied. The MPEG encoder 7 is adapted to digitize and subsequently encode the received analog television signal FS and to supply a second MPEG-2 transport stream TS2 comprising the audio information, video information and possibly additional information of the television signal FS. Such an MPEG encoder 7 has been known for a long time, and will therefore not be further described.

The hard disk recorder 1 further comprises receiving means 8 for receiving audio data AD and associated video data VD. For this purpose, the receiving means 8 can receive both the first MPEG-2 transport stream TS1 from the digital tuner 4 and the second MPEG-2 transport stream TS2 from the MPEG encoder 7. Dependent on the television broadcast station and the recording mode selected by the user with the aid of the keyboard 6, either the first MPEG-2 transport stream TS1, the second MPEG-2 transport stream TS2 or the audio data AD and video data VD of one of the MPEG transport streams TS1 or TS2 can be supplied by the receiving means 8.

The hard disk recorder 1 comprises recording means 9 which in a normal recording mode of the hard disk recorder 1 are adapted to record the first MPEG-2 transport stream TS1 or the second MPEG-2 transport stream TS2 supplied by the receiving means 8. When the user has activated the normal recording mode with the aid of the keyboard 6, all audio data AD, video data VD and possibly also additional data comprised in the MPEG-2 transport streams TS1 or TS2 supplied by the receiving means 8 are recorded as recording data RD on a record carrier of the recording means 9.

For this purpose, the recording means 9 comprise a hard disk interface 10 and a hard disk 11 as a record carrier. The hard disk interface 10 is adapted to control the number of revolutions of the hard disk 11 and to prepare the recording data RD to be recorded on the hard disk 11 in a generally known manner.

By activating one of the keys of the keyboards 6, a normal reproducing mode of the hard disk recorder 1 can be activated in a manner not further shown in FIG. 1. The hard disk interface 10 and the hard disk 11 constitute reproducing means for reproducing the recording data AD recorded on the hard disk 11, which data are supplied as reproducing data WD to the hard disk interface 10.

The hard disk recorder 1 further comprises supply means 12 comprising an MPEG-2 decoder, an analog video encoder and an audio processing stage. In the normal reproducing mode activated in the hard disk recorder 1, the reproducing data WD supplied to the hard disk interface 10 are supplied as third MPEG-2 transport stream TS3 to the supply means 12. The video data VD comprised in the third MPEG-2 transport stream TS3 are decoded with the MPEG-2 decoder and supplied as so-called RGB video signal to the analog video encoder. The analog video encoder processes the RGB video signal supplied thereto into a so-called CVBS video signal CVBS which can be supplied to a video output terminal AV of the hard disk recorder 1. The audio processing stage of the supply means 12 process the audio data AD comprised in the third MPEG-2 transport stream TS3 and supply these as analog audio signal AS from an audio output terminal AA.

A television apparatus 13 is connected to the video output terminal AV and the audio output terminal AA of the hard disk recorder 1. In a normal reproducing mode activated in the hard disk recorder 1, the video information and the audio information reproduced by the hard disk recorder 1 can be visually and acoustically reproduced, respectively, by means of the television apparatus 13.

The hard disk recorder 1 further comprises selection means 14 to which the MPEG-2 transport stream TS1 or TS2 supplied by the receiving means 8 can be applied. The selection means 14 are adapted to select the video data VD comprising the information of frames of the television broadcast and associated time-stamp information from the video data VD comprised in the MPEG-2 transport stream TS1 or TS2. To this end, the selection means 14 select the video data VD comprising the I-frames I from the video data VD of the MPEG-2 transport stream TS1 or TS2 and supply them as selected video data AVD.

The hard disk recorder 1 also comprises selection means 15 to which the video data AVD selected by the selection means 14, i.e. all I-frames I of the MPEG-2 transport stream TS1 or TS2 can be applied. The selection means 15 are adapted to select at least one and maximally N of the frames (I-frames) selected during a partial broadcast period TD. The partial broadcast period TD corresponds to a part of the complete broadcast period of the television broadcast, which will be further described with reference to an embodiment of the hard disk recorder 1 shown in FIG. 1.

In this embodiment it has been assumed that the user of the hard disk recorder 1 would like to record a concert with a broadcast time of five hours, a news report about the US elections with a broadcast time of three hours and a news report with a broadcast time of five minutes on the hard disk 11. Since in the normal recording mode of the hard disk recorder 1, television broadcasts can be recorded with a maximal overall broadcast time of four hours, the user activates the frame recording mode of the hard disk recorder.

The operation of the hard disk recorder 1 in the case of an activated frame recording mode will now be further described with reference to FIG. 3 for recording the news report having the broadcast period SD of five minutes. The video data VD of the first MPEG-2 transport stream TS comprising the news broadcast are supplied by the receiving means 8 to the selection means 14.

During reception of the first MPEG-2 transport stream TS1, the selection means 14 continuously supply the video data VD of all I-frames I comprised in the first MPEG-2 transport stream TS1 and supply them to the selection means 15. During the broadcast period SD of five minutes, a total number of 600 I-frames I (300 seconds of broadcast period SD/0.5 seconds of group broadcast period TG) are selected. In FIG. 3, the first of these 600 I-frames I are denoted as I1, I2 and I3.

A partial broadcast period TD of one minute and a number N of 5 frames to be maximally selected in each partial broadcast period TD is fixed in the selection means 15. Thus, minimally one frame and maximally five frames are selected for recording by the selection means 15 from the selected I-frames I for each minute of the broadcast period SD. The selected video data SVD comprising the frame information of the selected frames, as well as the time-stamp information assigned to the frames are supplied by the selection means 15 to the hard disk interface 10 for the purpose of recording on the hard disk 11.

This provides the advantage that with an activated frame recording mode during the broadcast period SD of five minutes, selected video data SVD of maximally 25 frames, or I-frames I are recorded. In comparison with the 600 I-frames I, which were recorded in the activated normal recording mode, a maximum of one 24^{th} of the I-frames I is recorded in the frame recording mode. Consequently, 11 television broadcasts with an overall broadcast period of at least 98 hours can be recorded in the frame recording mode on the hard disk 11, which is very advantageous.

The required memory location for the audio data AD is very small as compared with the video data VD. In order that the user can hear the text of the news report of the overall news broadcast, all audio data AD comprised in the first MPEG-2 transport stream TS1 are recorded in the frame recording mode. To this end, all audio data AD comprised in the first MPEG-2 transport stream TS1 are supplied by the receiving means 8 to the hard disk interface 10 for recording on the hard disk 11.

Advantageously, no audio information of the news broadcast is lost. The frame recording mode is thus particularly advantageous in those television broadcasts in which the picture information changes to a small extent and whose actual information content is comprised in the audio information. Such television broadcasts are, for example, concerts, documentary films or news broadcasts.

When the user activates the frame reproducing mode for reproducing the news broadcast recorded in the frame recording mode, the audio data AD, the selected video data SVD and the associated time-stamp information of the news broadcast are read by the hard disk interface 10 as reproducing data WD from the hard disk 11. The hard disk interface 10 supplies reproduced audio data WAD comprised in the reproducing data WD, reproduced selected video data WSVD and all associated time-stamp information to the supply means 12. The supply means 12 process the reproduced audio data WAD and supply them continuously as an analog audio signal AS to the television apparatus 13.

The supply means 12 comprise a frame memory for storing the frame information received by the hard disk interface 10 in the reproduced selected video data WSVD. In the frame reproducing mode, the supply means 12 supply a frame, stored in the frame memory, as a CVBS signal to the television apparatus 13 until the time-stamp information of the frame subsequently received in the reproduced selected video data WSVD indicates that this frame must now be reproduced so as to ensure the synchronicity with the reproduced audio information.

This provides the advantage that the hard disk recorder 1 reproduces the overall audio information of the news broadcast in the frame reproducing mode and reproduces selected frames as still pictures until the next selected frame has occurred in the television broadcast.

The hard disk recorder 1 further comprises start detection means 16 which are adapted to detect the start of each television broadcast received in the received video data VD. In this case, the start detection means 16 are adapted to evaluate additional information transmitted in the MPEG-2 transport stream TS. Such additional information characterizing the start of television broadcasts is conventionally inserted by television stations into the MPEG-2 transport stream TS.

Furthermore, the start-detection means 16 are adapted, in a manner not further shown in FIG. 1, to detect a change of a VPS code comprised in the television signal FS, which VPS code change indicates the end or the beginning of a television broadcast. The start detection means 16 can supply start information AI to the selection means 15 when the beginning of a new television broadcast is detected in the received video data VD.

When receiving the start information AI, the selection means 15 are adapted to select the selected video data AVD of the first I-frame or the frame of the new television broadcast. This advantageously ensures that, in the frame reproducing mode, picture information with the audio information of this new television broadcast is supplied to the television apparatus 13 directly after the start of reproducing a new television broadcast.

The hard disk recorder 1 further comprises black-frame detection means 17 which are adapted to detect a so-called black frame in the received video data VD, characterizing a change of scenes in the television broadcast. Black frame information BI can be supplied by the black frame detection means 17 to the selection means 15 when a black frame is detected.

When receiving the black-frame information BI, the selection means 15 are adapted to select the selected video data AVD of the frame which succeeds the black frame. This advantageously ensures that the first frame of each scene is selected and recorded.

The hard disk recorder 1 further comprises frame-comparison means 18 which are adapted to compare characteristic features of consecutive selected frames and are formed as a result of the comparison for supplying a change value VW. The frame-comparison means 18 compare the grey values of consecutive frame information and supply the change value VW to the selection means 15. A strongly different grey value of consecutive frames is most probably a frame having a considerably changed picture content whose frame information should be recorded.

When receiving a change value VW exceeding a change threshold value, the selection means 15 are adapted to select the frame which has considerably changed with respect to the preceding frame. It is thereby advantageously achieved that characteristic frames (for example, picture information of the television broadcast changes from a wide shot of the orchestra to a close-up of the conductor) are selected and recorded.

By providing the start-detection means 16, the black-frame detection means 17 and the frame-comparison means 18 in the hard disk recorder 1, it has advantageously been achieved that the selection of frames by the selection means 15 does not take place arbitrarily but that a large information content for the frames in the television broadcast are recorded in the frame recording mode.

It is particularly advantageous to select the I-frames of a Group of Pictures corresponding to the MPEG-2 standard as frame information, because they have been encoded in accordance with the intraframe encoding method and because the MPEG-2 standard is very widely used. Selection means according to the invention may, however, also select frame information from any other digital data streams, of which some would then be selected by the selection means.

It should be noted that the recording device according to the invention may be adapted to record the selected frames on a read-only memory or a magnetic tape.

It should be noted that, as number N, also a substantially larger number than the number of five, or also the number of one, can be fixed. Consequently, for example, 30 frames per minute, or only one frame per 40 minutes (=partial broadcast period) would be recorded.

1. A recording device (1) for recording audio data (AD) and selected associated video data (SVD) of a television broadcast in a frame recording mode, the device comprising
receiving means (8) for receiving audio data (AD) and associated video data (VD), in which the received video data (VD) comprise, inter alia, intraframe-encoded information of frames of the television broadcast and time-stamp information, which time-stamp information characterizes the instants of occurrence of the frames in the television broadcast, and
selection means (14) for selecting the video data (VD) comprising the frame information and associated time-stamp information from the received video data (VD), and
selection means (15) for selecting at least one and maximally N of the frames selected during a partial broadcast period (TD), which partial broadcast period (TD) corresponds to a part of the overall broadcast period (SD) of the television broadcast, and
recording means (9) for recording the overall received audio data (AD) and the selected video data (SVD) comprising the information of the selected frames and associated time-stamp information on a record carrier (11).

2. A recording device (1) as claimed in claim 1, wherein black-frame detection means (17) for detecting a black frame in the received video data (VD) characterizing a change of scenes in the television broadcast are provided, and wherein the selection means (15) are adapted to select each selected frame which occurs after a black frame detected by the black-frame detection means (17).

3. A recording device (1) as claimed in claim 1, wherein frame comparison means (18) are provided which are adapted to compare characteristic features of consecutive selected frames and, as a result of the comparison, to supply a change value (VW), and wherein the selection means (15) are adapted to select a selected frame when the change value (VW) exceeds a change threshold value from the previously selected frame to this selected frame.

4. A recording device (1) as claimed in claim 1, wherein start-detection means (16) are provided which are adapted to detect the start of each television broadcast received in the received video data (VD), and wherein the selection means (15) are adapted to select the first selected frame of each television broadcast.

5. A recording device (1) as claimed in claim 1, wherein the selection means (15) are adapted to select at least one and maximally N=5 of the selected frames during the partial broadcast period (TD) of one minute.

6. A recording device (1) as claimed in claim 1, wherein the receiving means (8) are adapted to receive audio data (AD) and video data (VD) encoded in accordance with the MPEG-2 standard (ISO/IEC 13818), and wherein the frames are constituted by I frames (I) of a Group of Pictures (GOP).

7. A reproducing device (1) for reproducing audio data (AD) and video data (VD) in a frame recording mode, recorded on a record carrier (11) by means of a recording device (1) as claimed in claim 1 in a frame recording mode of the recording device (1), the device comprising
reproducing means (9) for reproducing the audio data (AD) and video data (VD) recorded on the record carrier (11), wherein the reproduced video data (VD) are formed by intraframe-encoded information of frames of a television broadcast and by time-stamp information, which time-stamp information characterizes the instant of occurrence of the frames in the television broadcast, and
supply means (12) for continuously supplying the reproduced audio data (WAD) and for time-limited supplying the reproduced information of a frame during a frame reproducing period, in which the start of the frame reproducing period is characterized by the time-stamp information assigned to the reproduced frame, and in which the end of the frame reproducing period is characterized by the time-stamp information assigned to the frame to be subsequently reproduced.

8. A reproducing device (1) as claimed in claim 7, wherein the reproducing means (9) are adapted to reproduce I frames (I) of a Group of Pictures (GOP) corresponding to the MPEG-2 standard (ISO/IEC 13818) as intraframe-encoded frame information.

9. A method of recording audio data (AD) and selected associated video data (SVD) of a television broadcast in a frame recording mode, the method comprising the steps of
receiving audio data (AD) and associated video data (VD), wherein the received video data (VD) comprise, inter alia, intraframe-encoded information of frames of the television broadcast and time-stamp information, which time-stamp information characterizes the instants of occurrence of the frames in the television broadcast,
selecting the video data (VD) comprising the frame information and associated time-stamp information from the received video data (VD),
selecting at least one and maximally N of the frames selected during a partial broadcast period (TD), which partial broadcast period (TD) corresponds to a part of the overall broadcast period (SD) of the television broadcast,
recording the overall received audio data (AD) and the selected video data (SVD) comprising the frame information of the selected frames and associated time-stamp information on a record carrier (11).

10. A recording method as claimed in claim 9, comprising the further steps of
detecting a black frame in the received video data (VD) characterizing a change of scenes in the television broadcast,
selecting each selected frame occurring after a detected black frame.

11. A recording method as claimed in claim 9, comprising the further steps of
comparing characteristic features of consecutive selected frames and supplying a change value (VW) as a result of the comparison,
selecting a selected frame when the change value (VW) exceeds a change threshold value from the previously selected frame to this selected frame.
